(19) United States
(12) Patent Application Publication
(10) Pub. No.: US 2005/0274855 A1
(43) Pub. Date: Dec. 15, 2005

(54) Display installation apparatus

(76) Inventor: Yong-ha Shin, Suwon-si (KR)

Correspondence Address: STANZIONE & KIM, LLP, 919 18TH STREET, N.W., SUITE 440, WASHINGTON, DC, 20006, US

(21) Appl. No.: 11/142,247

(22) Filed: Jun. 2, 2005

(30) Foreign Application Priority Data
Jun. 14, 2004 (KR) 2004-43729

(51) Int. Cl. A47K 1/00; F21V 35/00

(52) U.S. Cl. 248/220.22

(57) ABSTRACT

A display installation apparatus to install a display includes an installation bracket provided in an accommodating portion of an installation surface, a mounting bracket foldably connected to the installation bracket and to which the display is mounted, and a link unit provided between the mounting bracket and the installation bracket and allowing the mounting bracket to move toward and away from the installation bracket. The display installation apparatus allows a display to be easily mounted to and detached from the accommodating portion of the installation surface.

### CROSS-REFERENCE TO RELATED APPLICATIONS

This application claims the benefit of Korean Patent Application No. 2004-43729, filed on Jun. 14, 2004, in the Korean Intellectual Property Office, the disclosure of which is incorporated herein by reference.

### BACKGROUND OF THE INVENTION

1. Field of the Invention

The present general inventive concept relates to a display installation apparatus, and more particularly, to a display installation apparatus allowing a display to be easily mounted to and detached from an installation surface.

2. Description of the Related Art

Generally, a display installation apparatus is used for installing a display to a predetermined installation surface, wherein the display is a device for displaying a picture. As an example, the installation surface can include a floor, a wall, a ceiling, etc.

A flat panel display, such as a liquid crystal display (LCD), a plasma display panel (PDP) or the like, is relatively thin and therefore easily installed to the installation surface such as the wall or the like. On the other hand, recently, when a house is built, a wall thereof can be recessed to a predetermined depth to install a display, such as the LCD, the PDP or the like, thereon.

For example, a conventional display installation apparatus for installing a display to a wall is disclosed in Korean Patent First Publication No. 2004-25314. Such a conventional display installation apparatus comprises an upper main bracket having a first side mounted to an installation surface and a second side detachably coupled to a rear upper portion of a display; and a lower main bracket having a first side mounted to an installation surface and a second side detachably coupled to a rear lower portion of the display. Here, the upper and lower main brackets are formed with projection holders corresponding to projections provided on the upper and lower rear portions of the display.

With this configuration, the conventional display installation apparatus is applicable to various sizes of displays and has a relatively simple structure of the upper and lower main brackets, so that the display can be easily installed to the installation surface such as the wall or the like.

However, in a case where the conventional display installation apparatus is installed to the installation surface recessed to a predetermined depth to accommodate a small-sized display, a large-sized display is not easily mounted to or detached from the conventional display installation apparatus.

### SUMMARY OF THE INVENTION

The present general inventive concept provides a display installation apparatus allowing a display to be easily mounted to and detached from an accommodating portion of an installation surface.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a display installation apparatus to install a display, the display installation apparatus comprising an installation bracket provided in an accommodating portion of an installation surface, a mounting bracket foldably connected to the installation bracket and to which the display is mounted, and a link unit provided between the mounting bracket and the installation bracket and allowing the mounting bracket to move toward and away from the installation bracket.

The link unit may comprise a link shaft and first and second links crossing each other with respect to the link shaft so as to be folded.

The first link may have a first end rotatably coupled to the installation bracket and a second end slidably coupled to the mounting bracket, and the second link may have a first end rotatably coupled to the mounting bracket and a second end slidably coupled to the installation bracket.

The first ends of the first and second links may be respectively coupled with hinge shafts, and the installation bracket and the mounting bracket may be respectively formed with shaft accommodating holes to accommodate the hinge shafts therein. The second ends of the first and second links may be respectively coupled with sliding shafts, and the installation bracket and the mounting bracket may be respectively formed with elongated holes in which the sliding shafts slide.

The display installation apparatus may further comprise a torsion coil spring in which the link shaft is inserted, and which has a first end supported by the first link and a second end supported by the second link.

The mounting bracket may be provided with a grip.

The mounting bracket may move in parallel with the installation bracket.

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is a perspective view illustrating a display installation apparatus to detachably attach a display to a predetermined surface according to an embodiment of the present general inventive concept;

FIG. 2 is a perspective view illustrating an unfolded state of a mounting bracket and an installation bracket in the display installation apparatus of FIG. 1;

FIG. 3 is an exploded perspective view illustrating the display installation apparatus of FIG. 2;

FIG. 4 is a perspective view illustrating a link unit in the display installation apparatus of FIG. 3; and

FIGS. 5 through 8 are side views illustrating operations of a display installation apparatus according to an embodiment of the present general inventive concept.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

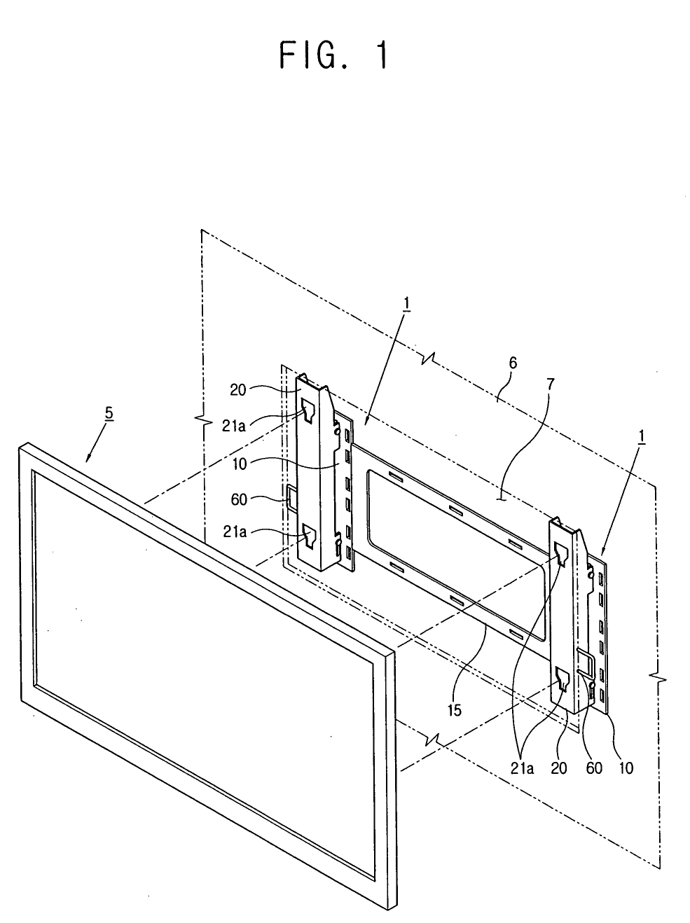

FIG. 1 is a perspective view illustrating a display installation apparatus 1 according to an embodiment of the present general inventive concept. The display installation apparatus 1 includes a device used for installing a display to a predetermined installation surface, wherein the display is formed with a picture-displaying portion. Here, the installation surface includes a floor, a wall, a ceiling, etc. Hereinbelow, the wall will be representatively described as the installation surface. The installation surface may be recessed to a predetermined depth to receive the display installation apparatus and/or the display.

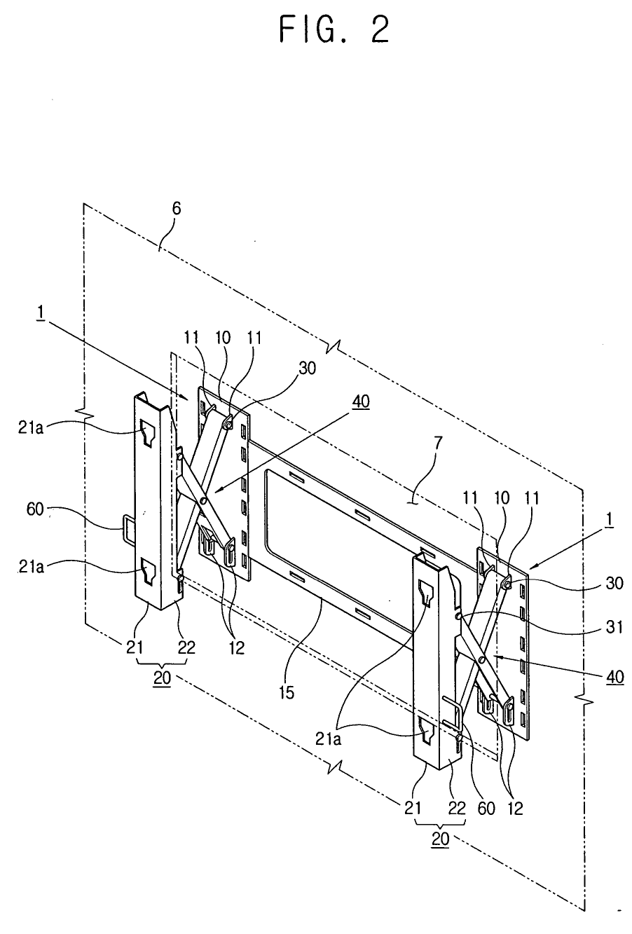

As shown in FIGS. 1 through 3, the display installation apparatus 1 comprises an installation bracket 10 to be installed to a wall 6, a mounting bracket 20 foldably connected to the installation bracket 10 and to which a display 5 is mounted, and a link unit 40 provided between the mounting bracket 20 and the installation bracket 10.

The link unit 40 comprises a link shaft 41 and first and second links 42 and 43 crossing each other with respect to the link shaft 41 so that the first and second links 42 and 43 can be folded.

The installation bracket 10 forms a pair with another installation bracket 10 and is installed to an accommodating portion 7 recessed by a predetermined depth from the wall 6. The pair of installation brackets 10 are spaced from each other within the accommodating portion 7 of the wall 6 and connected by a connecting bracket 15.

Each installation bracket 10 is provided with a pair of upper projections 11 protruding frontward and to which a first end of the first link 42 is coupled. Each upper projection 11 is formed with a first shaft accommodating hole 11a in which a first hinge shaft 30 is inserted. The pair of upper projections 11 are spaced from each other by a distance wider than a width of the first link 42, so that the first link 42 is accommodated between the pair of upper projections 11. Further, each installation bracket 10 is provided with a pair of lower projections 12 protruding frontward and to which a second end of the second link 43 is coupled. Each lower projection 12 is formed with a second elongated hole 12a in which a second sliding shaft 32 is inserted and slides up and down. The pair of lower projections 12 is spaced from each other by a distance wider than a width of the second link 42, so that the second link 43 is accommodated between the pair of lower projections 12.

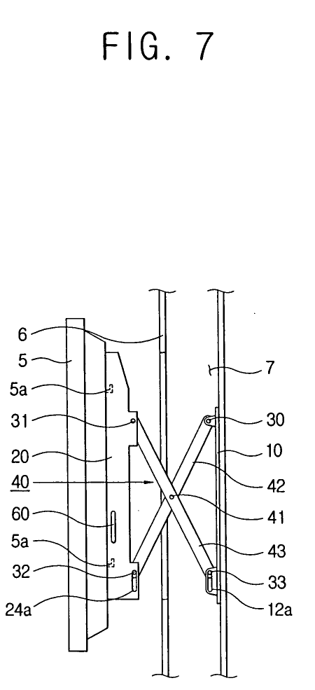

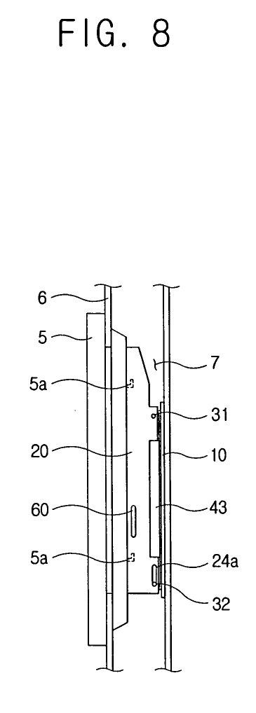

The mounting bracket 20 has a “□”-shaped section and forms a pair with another mounting bracket 20 in correspondence to the pair of installation brackets 10. Each mounting bracket 20 comprises a contact portion 21 to contact a rear side of the display 5, and a bending portion 22 bent backward from the contact portion 21 toward the installation bracket 10. On a surface of the contact portion 21 is formed with projection holders 21a corresponding to projections 5a (refer to FIGS. 7 and 8) formed in the rear side of the display 5. Thus, the projections 5a of the display 5 are respectively inserted in the projection holders 21a of the mounting bracket 20, so that the display 5 is mounted to the mounting bracket 20. Further, the bending portion 22 has an upper extended portion 23 extended toward the installation bracket 10 and supporting a first end of the second link 43, and a lower extended portion 24 extended toward the installation bracket 10 and supporting a second end of the first link 42. The upper extended part 23 is formed with a second shaft accommodating hole 23a in which a second hinge shaft 31 is accommodated, and the lower extended part 24 is formed with a first elongated hole 24a in which a first sliding shaft 33 is inserted and slides up and down.

The mounting bracket 20 can move in parallel with the installation bracket 10 through the link unit 40. Thus, the display 5 can be mounted to or detached from the mounting bracket 20 in a state that the display 5 is moved frontward from the recessed accommodating portion 7. Further, the mounting bracket 20 is provided with a grip 60, thereby allowing a user to grip the grip 60 and easily move the mounting bracket 20 frontward and backward.

The link unit 40 allows the mounting bracket 20 to move closer and away from the installation bracket 10. The first link 42 of the link unit 40 has the first end rotatably coupled to the installation bracket 10, and the second end slidably coupled to the mounting bracket 20. The second link 43 of the link unit 40 has the first end rotatably coupled to the mounting bracket 20 and the second end slidably coupled to the installation bracket 10.

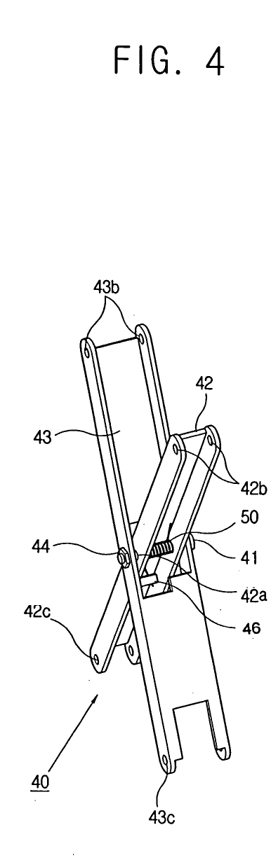

The first link 42 substantially has a “□”-shaped section. The first end of the first link 42 is formed with a first hinge shaft through hole 42b aligned with the first shaft accommodating hole 11a of the installation bracket 10 and into which the first hinge shaft 30 is inserted. The second end of the first link 42 is formed with a first sliding shaft through hole 42c aligned with the first elongated hole 24a of the mounting bracket 20, and the first sliding shaft 33 is inserted into the first elongated hole 24a and the first sliding shaft through hole 42c. Further, a middle portion of the first link 42 is formed with a first link shaft insertion hole 42a (FIG. 4) in which the link shaft 41 is inserted.

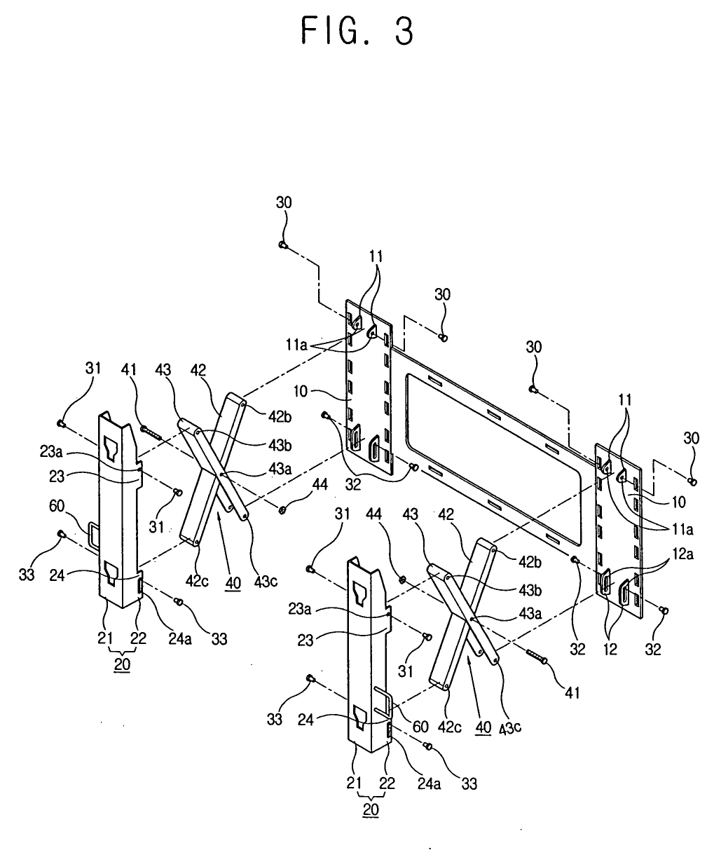

The second link 43 substantially has a “□”-shaped section. The first end of the second link 43 is formed with a second hinge shaft through hole 43b aligned with the second shaft accommodating hole 23a of the mounting bracket 20 and into which the second hinge shaft 31 is inserted. The second end of the second link 43 is formed with a second sliding shaft through hole 43c aligned with the second elongated hole 12a of the installation bracket 10, and the second sliding shaft 32 is inserted into the second elongated hole 12a and the second hinge shaft through hole 43b. Further, a middle portion of the second link 43 is formed with a second link shaft insertion hole 43a (FIGS. 3 and 4) in which the link shaft 41 is inserted, corresponding to the first link shaft insertion hole 42a of the first link 42. The link shaft 41 passes through the first and second link shaft insertion holes 42a and 43a and is then fastened with a nut 44. As the link shaft 41 and the nut 44 are fastened to each other, friction is generated between the first link 42 and the second link 43, thereby resisting a mutual rotation between the first and second links 42 and 43. Meanwhile, the width of the second link 43 is wider than that of the first link 42, so that the second link 43 rotates with respect to the link shaft 41 and then moves toward the first link 42, thereby accommodating the first link 42 therein.

Further, as shown in FIG. 4, a torsion coil spring 50 can be provided between the first and second links 42 and 43. The link shaft 41 passes through the torsion coil spring 50. The torsion coil spring 50 has a first end supported by the first link 42 and a second end supported by the second link 43, and has elasticity allowing the display 5 to resist a movement to move away from the wall 6. The second link 43 can be provided with a spring supporter 46 to support the second end of the torsion coil spring 50.

The elasticity of the torsion coil spring 50 allows the second link 43 to resist a rotation to rotate with respect to the first link 42 and a movement to move away from the first link 42. Thus, the torsion coil spring 50 elastically pulls the display 5 toward the wall 6. The elasticity of the torsion coil spring 50 may be smaller than the friction due to a fastening force between the link shaft 41 and the nut 44.

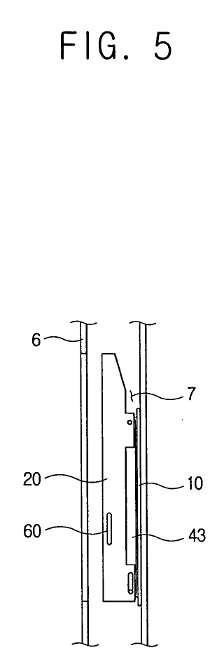

Hereinbelow, a process of mounting the display 5 to the display installation apparatus 1 according to an embodiment of the present invention will be described with reference to FIGS. 5 through 8.

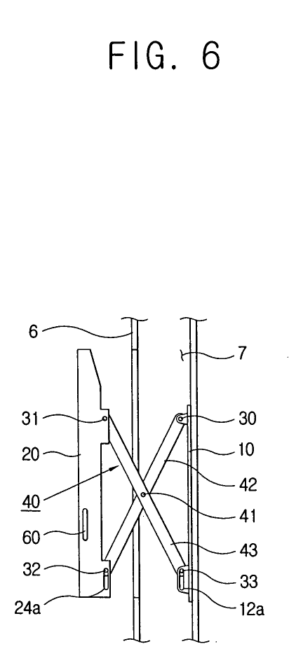

FIG. 5 illustrates that the display installation apparatus 1 is accommodated in the accommodating portion 7 of the wall 6. In this state, the first link 42 is accommodated in the second link 43, so that the first link 42 and the second link 43 are folded with each other. Then, to mount the display 5 to the display installation apparatus 1, referring to FIG. 6, a user grips the grip 60 and pulls the mounting bracket 20 frontward from the accommodating portion 7 of the wall 6, thereby extracting the mounting bracket 20 from the accommodating portion 7. At this time, the first link 42 and the second link 43 are rotated with respect to the link shaft 41, and the first sliding shaft 33 and the second sliding shaft 32 respectively move up along the first elongate hole 24a and the second elongate hole 12a, so that the installation bracket 10 and the mounting bracket 20 can move away from each other. Also, the elasticity of the torsion coil spring 50 facilitates the extraction of the mounting bracket 20, thereby allowing the user to easily extract the mounting bracket 20 frontward. Further, an extracted state of the mounting bracket 20 is maintained by the friction due to the fastening force between the link shaft 41 and the nut 44.

Referring to FIG. 7, to mount the display 5 to the mounting bracket 20, the projections 5a formed on the rear side of the display 5 are respectively inserted in the projection holders 21a of the mounting bracket 20. Then, to accommodate the extracted mounting bracket 20 in the accommodating portion 7 of the wall 6 again, referring to FIG. 8, the user pushes the display 5 toward the wall 6 and makes the first link 42 and the second link 43 be folded. At this time, the first link 42 and the second link 43 are rotated with respect to the link shaft 41, and the first sliding shaft 33 and the second sliding shaft 32 respectively move down along the first elongate hole 24a and the second elongate hole 12a, so that the installation bracket 10 and the mounting bracket 20 can be completely folded. Thus, the display installation apparatus 1 is not exposed outside through an opening of the wall 6 and is accommodated in the accommodating portion 7 of the wall 6, so that an outer appearance thereof is beautified and neat, thereby improving an amenity quality.

In the foregoing embodiment, the torsion coil spring 50 is provided between the first link 42 and the second link 43 and has the elasticity to resist the friction force. However, various springs, such as a flat spring, a coil spring or the like, may be provided to at least one rotatable position among the first link, the second link, the mounting bracket and the installation bracket as long as the spring can provide the elasticity.

In the foregoing embodiment, a pair of display installation apparatuses 1 can be used for a one display 5, wherein the display installation apparatuses 1 are symmetrically connected by the connecting bracket 15. However, one display installation apparatus or three or more display installation apparatuses can be employed for one display according to a size of the display 5.

As described above, the present general inventive concept provides a display installation apparatus through which a display can be easily mounted to and detached from an accommodating portion of an installation surface.

Although a few embodiments of the present general inventive concept have been shown and described, it will be appreciated by those skilled in the art that changes may be made in these embodiments without departing from the principles and spirit of the invention, the scope of which is defined in the appended claims and their equivalents.

1. A display installation apparatus to install a display, comprising:
an installation bracket provided in an accommodating portion of an installation surface;
a mounting bracket foldably connected to the installation bracket and to which a display is mounted; and
a link unit provided between the mounting bracket and the installation bracket and allowing the mounting bracket to move toward and away from the installation bracket.

2. The display installation apparatus according to claim 1, wherein the mounting bracket moves in parallel with the installation bracket when the mounting bracket moves toward and away from the installation bracket.

3. The display installation apparatus according to claim 1, wherein the link unit comprises a link shaft and first and second links crossing each other with respect to the link shaft so as to be folded when the installation bracket is move toward the mounting bracket.

4. The display installation apparatus according to claim 3, wherein the mounting bracket moves in parallel with the installation bracket when the mounting bracket moves toward and away from the installation bracket.

5. The display installation apparatus according to claim 3, wherein the first link comprises a first end rotatably coupled to the installation bracket and a second end slidably coupled to the mounting bracket, and the second link comprises a first end rotatably coupled to the mounting bracket and a second end slidably coupled to the installation bracket.

6. The display installation apparatus according to claim 5, wherein the mounting bracket moves in parallel with the installation bracket when the mounting bracket moves toward and away from the installation bracket.

7. The display installation apparatus according to claim 5, wherein:
the first ends of the first and second links are respectively coupled with hinge shafts, and the installation bracket and the mounting bracket are respectively formed with shaft accommodating holes to accommodate the hinge shafts therein; and
the second ends of the first and second links are respectively coupled with sliding shafts, and the installation bracket and the mounting bracket are respectively formed with elongated holes in which the sliding shafts slide.

8. The display installation apparatus according to claim 7, wherein the mounting bracket moves in parallel with the installation bracket when the mounting bracket moves toward and away from the installation bracket.

9. The display installation apparatus according to claim 7, further comprising:
a torsion coil spring in which the link shaft is inserted and which has a first end supported by the first link and a second end supported by the second link.

10. The display installation apparatus according to claim 9, wherein the mounting bracket moves in parallel with the installation bracket.

11. The display installation apparatus according to claim 9, wherein the mounting bracket comprises a grip.

12. The display installation apparatus according to claim 11, wherein the mounting bracket moves in parallel with the installation bracket when the mounting bracket moves toward and away from the installation bracket.

13. The display installation apparatus according to claim 1, wherein the accommodating portion is recessed from the installation surface by a predetermined depth, and the mounting bracket, the installation bracket, and the link unit are disposed in the accommodating portion not to protrude from the installation surface when the mounting bracket is move toward the installation bracket according to a movement of the link unit.

14. The display installation apparatus according to claim 1, wherein the accommodating portion is recessed from the installation surface by a predetermined depth, and the mounting bracket and a portion of the link unit are disposed in the accommodating portion not to protrude from the installation surface while the mounting bracket and a remaining portion of the link unit is exposed to an outside of the accommodating portion with respect to the installation surface, when the mounting bracket is move away from the installation bracket according to a movement of the link unit.

14. The display installation apparatus according to claim 1, wherein the accommodating portion is recessed from the installation surface by a predetermined depth, and the installation bracket has a thickness less than the predetermined depth.

15. The display installation apparatus according to claim 1, wherein the accommodating portion is recessed from the installation surface by a predetermined depth, and a sum of thicknesses of the installation bracket and the link unit is less than the predetermined depth.

16. The display installation apparatus according to claim 1, wherein the accommodating portion is recessed from the installation surface by a predetermined depth, and a sum of thicknesses of the installation bracket, the link unit, and the mounting bracket is less than the predetermined depth.

17. The display installation apparatus according to claim 1, wherein the link unit comprises a first link and a second link crossing each other and each having both ends coupled to the installation bracket and the mounting bracket, a hinge to couple the first link and the second link with a friction force, and an elastic element having both ends coupled to the first link and the second link, respectively.

18. The display installation apparatus according to claim 17, wherein the mounting bracket comprises a contact portion disposed parallel to the installation bracket and an extended portion extended toward the installation bracket, and the first link and the second link have a thickness less than a length of the extended portion.

19. The display installation apparatus according to claim 18, wherein the first link is disposed with the second link when the first link and the second link are folded, and the first and second links are disposed within the extended portion.
